(19) United States
(12) Patent Application Publication
(10) Pub. No.: US 2005/0159309 A1
(43) Pub. Date: Jul. 21, 2005

(54) Environmental coatings assemblies

(76) Inventors: David A. Hubbell, Pensacola, FL (US); Mary C. Hubbell, Pensacola, FL (US)

Correspondence Address: David A. Hubbell, Apt. #128, 1600 Governors Dr., Pensacola, FL, 32514, US

(21) Appl. No.: 11/031,560

(22) Filed: Jan. 8, 2005

Related U.S. Application Data
(60) Provisional application No. 60/536,161, filed on Jan. 12, 2004.
(60) Provisional application No. 60/540,993, filed on Feb. 2, 2004.

(51) Int. Cl. B01J 21/04

(52) U.S. Cl. 502/439; 404/10

(57) ABSTRACT

A highway safety equipment system using solid catalyst crystal, such as titanium dioxide, targeted for the breakdown of fluid borne undesirable material, such as “smog” utilizing standard, commonly encountered, U.S. Federal Highway Administration (FHWA), National Cooperation Highway Research Program (NCHRP), and/or American Association of State Highway and Transportation Officials' (AASHTO) Standard Specification items such as highway guiderail, highway signing, highway signal equipment, housings, toll booth, bridgework, bridgerails and/or such items' support structures.

### RELATED APPLICATIONS

This application claims the benefit of Provisional application Ser. Nos. 10/397,842 filed Mar. 27, 2003, 60/536,161 filed Jan. 12, 2004, and 60/540,993 filed Feb. 2, 2004.

U.S. Patent Documents

| | | |
|---|---|---|
| 14,267 | February 1856 | Hoff |
| 46,049 | January 1865 | Henry |
| 1,789,812 | January 1931 | Frazer |
| 2,394,030 | February 1946 | Wainer |
| 2,501,846 | March 1950 | Gifford |
| 3,067,115 | December 1962 | Clingman, Jr. |
| 3,731,459 | May 1973 | Foster |
| 3,791,752 | February 1974 | Gardner |
| 3,983,956 | October 1976 | Manhart |
| 4,031,875 | June 1977 | Tyler |
| 4,037,561 | July 1977 | LaFave, et al. |
| 4,168,112 | September 1979 | Ellis, et al. |
| 4,231,080 | October 1980 | Compton |
| 4,358,090 | November 1982 | Glaesener |
| 4,574,038 | March 1986 | Wan |
| 4,674,593 | June 1987 | McCarty |
| 4,684,537 | August 1987 | Graetzel, et al. |
| 4,750,917 | June 1988 | Fujii |
| 4,751,005 | June 1988 | Mitsui, et al. |
| 4,788,038 | November 1988 | Matsunaga |
| 4,806,514 | February 1989 | Langford, et al. |
| 4,861,484 | August 1989 | Lichtin, et al. |
| 4,863,608 | September 1989 | Kawai, et al. |
| 4,864,476 | September 1989 | Lemons, et al. |
| 4,892,712 | January 1990 | Robertson, et al. |
| 4,899,498 | February 1990 | Grieb |
| 4,966,665 | October 1990 | Ibusuki, et al. |
| 4,966,759 | October 1990 | Robertson, et al. |
| 4,997,576 | March 1991 | Heller, et al. |
| 5,045,288 | September 1991 | Raupp, et al. |
| 5,069,693 | December 1991 | Blikken, et al. |
| 5,069,885 | December 1991 | Ritchie |
| 5,126,111 | June 1992 | Al-Ekabi, et al. |
| 5,252,190 | October 1993 | Sekiguchi, et al. |
| 5,272,378 | December 1993 | Wither |
| 5,329,438 | July 1994 | Thompson |
| 5,449,443 | September 1995 | Jacoby, et al. |
| 5,501,801 | March 1996 | Zhang,etal. |
| 5,689,798 | November 1997 | Oeste |
| 5,700,559 | December 1997 | Sheu, et al. |
| 5,779,912 | July 1998 | Gonzalez-Martin, et al. |
| 5,945,231 | August 1999 | Narayanan, et al. |
| 6,214,195 | April 2001 | Yadav, et al. |
| 6,367,208 | April 2002 | Campbell et al. |
| 6,398,851 | June 2002 | Bose |
| 6,409,433 | June 2002 | Hubbell et al. |
| 6,454,488 | September 2002 | Lewis et al. |
| 6,502,805 | January 2003 | Lewis et. al. |
| 6,536,177 | March 2003 | Italiane et al. |
| 6,561,492 | May 2003 | Hubbell |
| 6,569,386 | May 2003 | Ko et al. |
| 6,676,279 | January 2004 | Hubbell, et al. |
| 6,685,154 | February 2004 | Blyth et. al. |
| 6,705,744 | March 2004 | Hubbell, et al. |
| 6,792,259 | September 2004 | Parise |

### OTHER REFERENCES

Principles of Fluid Mechanics, by Wen-Hsiung Li and Sau-Hai Lam, Addison-Wesley Publishing © 1964
WO 97/38570 (PCT/US96/05121), 15 Apr. 1996 to Redford
WO 02/066745 (PCT/IS01/00005), 19 Feb. 2001 to Jonsson and Hubbell
“Smart Material Can Both Detect and Eliminate Water Pollutants” Feb. 6, 2002, © Scientific American, Inc.
“Paving Out Pollution, A Common Whitener Helps To Clean The Air” By Linda Wang, Feb. 23, 2002, © Scientific American, Inc.
Federal Highway Administration (FHWA) Opinion Letter, Dec. 8, 2000, to Adirondack Ironwood Rail Corporation (AIR CORP)
Federal Highway Administration (FHWA) Opinion Letter, Aug. 9, 2004, to Adirondack Ironwood Rail Corporation (AIR CORP)
“A Study on Wind and Snow Impact On Guide Rails”, by Dus/Batteriid EHF, Hafnarfjorour, Iceland, November 2000
“Smog regulations just got tougher”, Christian Science Monitor, Apr. 22, 2004, page 2
“Photochemical Smog: mechanism, ill-effects, and control”, by P. Kumar & D. Mohan, TERI Information Digest on Energy and Environment, Volume 1, Number 3, September 2002
12th International Symposium on Environmental Pollution Oct. 4-8, 2003 by Th. Maggos, D. Kotzias, J. G. Bartzis, P. Leva, Ch. Vassilakos

### BACKGROUND OF THE INVENTION

The present invention relates generally to a structural assembly for maintaining viable contact between catalyst crystal surfaces and fluid(s) bearing targeted elements, molecules, compounds, organisms and the like. (from Pro. Pat. '161).

America's highway corridors generate significant quantities of pollution. Major portions of said corridors constitute the National Highway System (NHS). The acronym NHS will be used herein to include all motor vehicle right-of-ways.

“80% of “smog” is traceable to the public sector's motor vehicle highway corridors.” (“Smog regulations just got tougher”, Christian Science Monitor, Apr. 22, 2004, page 2).

“Prolonged exposure can eventually damage lung tissue, cause premature aging of the lungs, and contribute to chronic lung disease. Children, the elderly, and people with impaired lung function are considered to be most at risk.” (“Photochemical Smog: mechanism, ill-effects, and control”, by P. Kumar & D. Mohan, TER1 Information Digest on Energy and Environment, Volume 1, Number 3, September 2002),

“EXHAUST POLLUTANT nitric oxide breaks down when sunlight hits the titanium dioxide . . . releasing reactive oxygen that turns NOx to nitric acid ions. . . . which are washed away by rain.” “In the early 1970s researchers from the University of Tokyo described titanium dioxide's (TiO2) photocatalytic abilities . . . . In Hong Kong, concrete slabs coated with titanium dioxide removed up to 90 percent of nitrogen oxides, most commonly spewed from older cars and diesel trucks and a contributor to smog, acid rain and other environmental headaches . . . a coating of titanium dioxide did in minutes what the environment does in months, . . . because titanium dioxide is a catalyst, it could last forever.” “In 2002, after 7000 square metres of road surface in Milan, Italy, were covered with a photo-catalytic cement-like material, there was up to 60% reduction in the concentration of nitrogen oxides at street level.” (“Paving Out Pollution, A Common Whitener Helps To Clean The Air” By Linda Wang, Feb. 23, 2002, ® Scientific American, Inc.).

Presented at the 12th International Symposium on Environmental Pollution Oct. 4-8, 2003 by Th. Maggos, D. Kotzias, J. G. Bartzis, P. Leva, Ch. Vassilakos: “Introduction The definition of photo-catalysis is . . . the acceleration of a photoreaction by the presence of a catalyst. Such a catalyst is TiO2, which . . . has . . . extremely strong oxidizing properties. This reaction is considered to have a cleaning effect on atmospheric air as it causes NOX pollutants to break down into nitric ions, removing nitrogen oxide from air.

Experimental Conditions The experiments were conducted in an environmental cell . . . By means of a small fan (placed inside the cell) the air was accelerated, so that a maximum contact of the air . . . with the TiO2-sample was guaranteed.

Results and Discussion The . . . photo-catalytic degradation of NO and NO₂ as well as the photo-catalytic velocity of these pollutants were calculated. After six hours of irradiation . . . 32% of NO₂ and 89% of NO was photo-catalytically degraded, . . . .”

Dr. Dimitrios Kotzias, of the EU's Joint Research Centre in Ispra, Italy, states that for titanium dioxide surfaces to be effective in “smog-busting”, air turbulence is required so that air mass is constantly carrying the gases over the surface, yet molecules stick to the surface long enough for the oxidation reaction to break them down.

The present invention is described using terms defined below: Principles of Fluid Mechanics by Wen-Hsiung Li and Sau-Hai Lam, Addison-Wesley Publishing © 1964 (Li & Lam), page 1, “Fluids may be defined as materials which continue to deform in the presence of any shearing stress.” “As a contrast, a solid under shearing stresses can remain in a deformed position if the stresses do not exceed a certain limit.” “In fluid mechanics, fluids are considered to be continuous although they, like any substance, consist of discrete molecules.” “For example, there are about 2.7×1016 molecules in one cubic millimeter of air under atmospheric conditions.” (Li & Lam, page 2) “Fluids may be classified into two groups, namely, liquids and gases.” (Li & Lam, page 253) “In a turbulent flow, the velocity at a point fluctuates at random with high frequency . . . As a result, mixing of the fluid is much more intense than in a laminar flow, where mixing is affected by molecular action. Thus physical characteristics at a point . . . are spread much more readily to other points in a turbulent flow.” “Similarly, high concentration of momentum is readily dispersed in a turbulent flow, resulting in a velocity distribution much more uniform than that of a laminar flow.” “If the flow in a laminar boundary layer is made turbulent (e.g. by roughening the solid surface), the velocity will become more uniform and higher, and as a result, fluid particles in the boundary layer can move farther downstream before separation takes place.” (italics in original).

Wind tunnel research conclusively shows that standard NHS-type highway guiderail converts laminar air-flow to turbulent air-flow thereby providing both a vortex scouring effect on exposed guiderail surfaces and Dr. Kotzias' requirement of constantly carrying “smog” over highway guiderail surfaces. (“A Study on Wind and Snow Impact On Guide Rails”, by Dus/Batteriid EHF, Hafnarfjorour, Iceland, November 2000).

“The fact that TiO2, when activated with UV light acts as a photocatalyst that oxidizes a range of pollutants has been known for a long time” (Dr. H. Ezzat Khalifa, Director, STAR Center for Environmental Quality Systems, Syracuse University, E-traffic Sep. 15, 2004).

The present invention addresses problem issues with prior art methods of fixing, and keeping clean or uncovered, crystal structures of a catalyst nature, such as the use of titanium dioxide in near-travelway applications for the purpose of reducing atmospheric phenomena known as “smog” and/or “acid-rain” and providing an improved visibly pleasing external appearance for prior art applications. (from Pro. Pat. '161).

The primary function of catalysts are (OED) substance(s) which when present in small amounts increases the rate of a chemical reaction or process but which is chemically unchanged by the reaction; . . . (A substance which similarly slows down a reaction is occas. called a negative catalyst.) (from Pro. Pat. '161).

The present invention is directed to certain design and performance issues regarding crystal catalysts and/or negative catalyst crystals. (from Pro. Pat. '161).

Catalyst performance requires that the catalyst's structure be physically in the presence of the chemicals involved in the reaction or process. Frequently, such as in the case of highway and near-highway environments, certain industrial processes and/or architecturally configurations, the targeted aforementioned chemicals are a relatively small percentage of the liquid or gas fluids in potential physical contact with the catalyst's structure. In the particular case of titanium dioxide as a catalyst in breaking down “smog” and/or “acid-rain”, the fluid composition of the near-highway environment includes dirt, soil, exhausted unburned hydrocarbons and such which can coat and thereby physically remove the titanium dioxide from being in the presence of the “smog” and thereby unable to catalyze the chemical reaction. (from Pro. Pat. '161).

Frequently the industrial, architectural or transportation in-situ environment includes vibration and/or physical shock thereby requiring a significant structural support mechanism for the catalyst element. (from Pro. Pat. '161).

U.S. Pat. No. 2,394,030 to Wainer (Wainer '030) teaches of the use of titanium dioxide in dielectric materials. (from Pro. Pat. '161).

U.S. Pat. No. 6,536,177 to Italiane et al. (Italiane '177) teaches of a titanium dioxide embedded composite structure which mimics the appearance but not the utility of elements of civil works structures. (from Pro. Pat. '161).

U.S. Pat. No. 6,569,386 to Ko et al. (Ko '386) teaches of a titanium dioxide and metal structure but such does not anticipate such use in commonly encountered civil works structures. (from Pro. Pat. '161).

The prior art offers a large number of means and methods, devices, addressing pollution prevention-mitigation geographical generated within the boundaries of the NHS. Such pollution prevention-mitigation efforts can be identified as private-sector and public-sector. Examples of private-sector pollution prevention-mitigation efforts include vehicle-equipped catalytic-converters addressing air-pollution issues (see U.S. Pat. No. 1,789,812 to Frazer) and tailpipe mufflers addressing noise-pollution issues. Examples of public-sector pollution prevention-mitigation efforts include highway sound-barriers addressing noise-pollution issues and mono-wavelength highway lighting addressing light-pollution. That said, the prior art is sparse of public-sector air-pollution prevention-mitigation means and methods or devices. Of those public-sector air-pollution prevention-mitigation means and methods or devices, none are known to the present inventors as having been deployed even as prototypes.

Public-sector light-pollution and noise-pollution prevention-mitigation devices are in wide use particularly on the NHS. There are no viable public-sector air-pollution prevention-mitigation devices in use on the NHS. The present invention addresses the need for public-sector air-pollution prevention-mitigation on the NHS.

Placement of equipment, of any type or configuration for any utilization, within NHS right-of-way requires meeting all applicable engineering, architecture, and safety specifications. Such specifications are usually Federal and State requirements. The present invention utilizes existing Federal and State approved, for use on the NHS, materials, equipment and devices to meet said specification. The prior art and literature is very sparse in the use of Federal and State approved, for use on the NHS, devices for the prevention-mitigation of air-pollution.

The primary reason for NHS air-pollution is explained in U.S. Pat. No. 4,031,875 to Tyler (Tyler '875). Tyler '875 teaches that (col. 1, line 12) “It is well known that gasoline fuel burns most efficiently in an internal combustion engine when it is in the form of a vapor. The conventional carburetor does not convert all of the gasoline passing therethrough into vapor, a substantial portion being, instead, merely broken up into tiny droplets that remain suspended in the intake air when the resulting mixture is drawn through the manifold and into the cylinders of an engine. While some vaporization takes place, a substantial portion of the gas remains in the form of liquid droplets in the cylinder head at the time the mixture is ignited by the spark. These liquid fuel droplets burn inefficiently, or incompletely, with the result that the engine exhaust contains an excessive amount of unburned hydrocarbons and carbon monoxide as air pollutants which contribute to the formation of atmospheric smog. Nitrogen oxide is also formed, as a smog-producing pollutant in the exhaust, because of high combustion temperatures in the engine, particularly at the point where the exhaust gases pass through the exhaust ports during the first few degrees of valve opening. These high temperatures are brought about when minute droplets of liquid fuel, still unburned, are vaporized by the heat of combustion to mix with the remaining oxygen, so that afterwards there is delayed combustion at an exceedingly high temperature when the gas is passed between the face of the valve and the valve seat. This high temperature is responsible for formation of the nitrogen oxide found in internal combustion engine exhaust gases.” The present invention incorporates these and other teachings of Tyler '875.

U.S. Pat. No. 6,398,851 to Bose (Bose '851) provides the present day response to Tyler '875's teachings and problem statements. Bose '851 teaches that (col. 1, line 57) “The exhaust gases which are emitted from present day automotive vehicles using unleaded gasoline consist primarily of unburned hydrocarbons (HC), carbon monoxide (CO), carbon dioxide (CO₂), other natural by-products of combustion and nitrogen oxides (NOx). The CO gas when inhaled by humans combine with their blood cells and prevents them from conveying the oxygen (O₂) content of air to their lungs, causing breathing problems. The HC and NOx constituents combine in the presence of heat and sunlight as they escape into the atmosphere to form Ozone (smog). Inhalation of Ozone has been documented to cause lung cancer. However, leaded gasoline operated automobiles also emit lead particles which causes lead poisoning if ingested by humans. Whereas, the diesel operated automobiles are known to emit micron size, carbon particles and sulfur dioxide/trioxide gases. The carbon particles are embedded in the human lungs, if inhaled and are known to cause lung cancer. The sulfur and nitrogen oxide gases are dissolved in rainwater to create acid rain which have devastated some forest lands through out the world.” (col. 2, line 25) “For the protection of our environment, the US Clean Air Act, 1970 stipulated the maximum emissions permissible for the various pollutant gases from new cars . . . ” (col. 2, line 33) “However, twenty years later, the US EPA observed the progressive degradation of the air quality of the one hundred largest U.S. cities to below the mandated limits of the said Act. The cause for this degradation was traced to the failure of the Catalytic Converter System about the sole automobile emission control system available ever since 1974 about by the deposit of lead particles on the platinum catalyst from the small quantity of lead in today's blend of the “lead free” (unleaded) gasoline. The non-methane HC gas conversion efficiency as a function of lead concentration on the catalyst of a three-way catalytic converter degrades from 100% to 48% with 0.01% about. 10% by weight of lead deposited on the catalyst: Reference: “Internal Combustion Engine Fundamentals”, Dr. John B. Heywood, Prof. Mech. Engineering, Massachusetts Institute of Technology, 1988, FIG. 11-55. McGraw Hill Publications.” (col. 2, line 52) “Similar degradation of the OEM catalytic converter has been recorded in the Federally-sponsored, “Reliability and Lifecycle Testing of The Automobile, Anti-Air Pollution and Energy Conservation System, hereafter referred to as the Bose System.” US D.O.E Report, March 1980.”

The present invention utilizes prior art photo-catalytic means and methods to breakdown smog components of air-pollution. Such photo-catalytic approaches are extensive in prior art. The prior art review of photo-catalytic design provided below is generally limited to the employment of titanium-dioxide. The present invention's preferred embodiment incorporates such material but it should be noted that the prior art and literature is very extensive and the offered is only a cursory review. To inventors' knowledge, there have been no prior teachings of using titanium-dioxide-type composite photo-catalysts deployed on Federal and State approved, for use on the NHS, materials, equipment and devices for the prevention-mitigation of air-pollution. The following are prior art reviews (the contents of which are incorporated herein by reference) of: a) public-sector air-pollution prevention-mitigation devices, b) public-sector light-pollution and noise-pollution prevention-mitigation devices, c) titanium-dioxide and like catalytic designs, d) availability of NHS site specific air turbulence.

a) Five public-sector air-pollution prevention-mitigation devices are identified, U.S. Pat. No. 3,731,459 to Foster, U.S. Pat. No. 3,791,752 to Gardner, U.S. Pat. No. 5,069,693 to Blikken et al., WO 97/38570 (PCT/US96/05121) 15 Apr. 1996 to Redford and U.S. Pat. No. 6,792,259 to Parise.

The present invention utilizes the teachings of U.S. Pat. No. 3,731,459 to Foster (Foster '459), entitled “Method and Apparatus for Treating Polluted Air Along Auto Traffic Arteries”. Foster '459 teaches that (col. 1, line 16) “There is an abundance of patent and commercial art relating to collecting stale or polluted air and circulating treated, purified and even refrigerated fresh air to the habitable interior areas of homes, buildings, trains, aircraft, automobiles and even to ventilation of subway tunnels. Some consideration has been given to means for venting poisonous gases that form in mine shafts and even to venting gases from metropolitan sewer systems but in all of these instances the great outdoor reservoir of air is both regarded as a source of fresh air and as a sewer dump into which polluted air may be dumped for removal by natural dispersion processes—we hope. However, any pedestrian standing on the sidewalk of a busy metropolitan automobile thoroughfare or standing near a bus stop can verify that natural dispersement processes do not remove smog and pollution from our metropolitan streets and sidewalks rapidly enough to prevent many people from becoming nauseated and seriously ill. A few dreamers have speculated about apparatus to gather smog and polluted air from drive in parking areas and streetside areas by means of special underground channels and expensive air treating apparatus.” (col. 1, line 46) “In order to cope with the overwhelming quantities of smog and street air pollution along metropolitan auto traffic thoroughfares a means is needed for inexpensively gathering polluted air from said traffic thoroughfares and routing said quantities of air to area air treatment and recirculation plants where a selected combination air treatment and purification procedures that employ inexpensive preliminary air scrubbing and air washing techniques to remove solid particles and major volume pollutants before the air is channeled through comparatively expensive saturatable and replaceable air filter systems such as activated charcoal.” Foster '459 provides (col. 1, line 62) “ . . . a method and apparatus by which smog and polluted air from metropolitan automobile thoroughfares may be pulled out of the streets and away from pedestrian sidewalks into storm sewer input openings and by exploiting the unused air space in conventional and already installed municipal storm sewers . . . ” The present invention incorporates these and other teachings of Foster '459, but does not pull smog and polluted air “ . . . into storm sewer input openings . . . ” nor does it exploit “ . . . already installed municipal storm sewers . . . .” Further, the present invention does not require Foster '459 device (col. 3, line 50) “ . . . power driven suction-blower fan . . . .”

The present invention utilizes the teachings of U.S. Pat. No. 3,791,752 to Gardner (Gardner '752), entitled “Highway Drainage and Exhaust System”. Gardner '752 teaches that (col. 1, line 32) “ . . . the development of the electric vehicle art is lulled to a virtual standstill . . . which . . . absent some major breakthrough will not yield results bringing equivalent performance in electric automobiles to I C (internal combustion) powered automobiles for some years to come . . . ” (col. 1, line 46) “In the years in the meantime awaiting the ‘ideal’ battery, the I C powered automobiles (the term automobiles herein used in the dictionary sense meaning general purpose highway vehicles and including trucks and buses) will continue to pollute the atmosphere and cause noise pollution perhaps at a lesser rate due to regulations increasing the quality of emissions but this savings being offset by the increasing numbers of I C vehicles.” (col. 2, line 9) “Exhaust noise transmitted via the outlets of exhaust pipes of I C vehicles currently in use has been attenuated to some extent upstream by the muffler designers but where a great concentration of vehicles are found a noise level measured in decibels exists which although tolerable for short periods by persons in the region of these vehicles, becomes intolerable over long periods of time and can affect the thought processes and work performances of many persons.” The Gardner '752 device provides for (col. 3, line 25) “ . . . an electric powered vehicle . . . ” having an “ . . . automatic guidance features and a duct arrangement for coupling thereto along the length of the highway below the highway surface.” The present invention incorporates these and other teachings of Gardner '752.

The present invention utilizes the teachings of U.S. Pat. No. 5,069,693 to Blikken, et al. (Blikken '693), entitled “System for Area Pollution Control”. Blikken '693 teaches that (col. 1, line 11) “The air pollution problems in many metropolitan areas due to industrial emissions and vehicular exhaust emissions is of great concern to residents of these areas. Various solutions have been suggested such as smaller engines in passenger vehicles, better emission control of engine exhausts, and possible ride sharing to reduce the overall number of vehicles traveling in rush hour traffic. The metro complex surrounding Los Angeles, Calif. is especially plagued with this problem of smog overlying the city. This due in part to the hills surrounding the city which trap and retain the polluted atmosphere and the absence of winds which would otherwise move the air out of the area.” (col. 1, line 23) “The Los Angeles area, in contrast to other large cities, has many open drain channels which collect and direct water resulting from rain storms to a suitable location for dispersion. It has been noted that a period of rain in the area will clear the air temporarily and the rain absorbs the air pollution and carries it off to the ocean, rivers, or collection basins.” The present invention incorporates these and other teachings of Blikken '693. (col. 1, line 31) “It is proposed to incorporate the open drain channels of an area, such as Los Angeles, in one or more pollution control systems which will move polluted air at ground level to one or more purification installations where the air may be cleaned and discharged.” Blikken '693 improves over Foster '459 by the inclusion of (col. 1, line 39) “ . . . top covers for the various storm drains which allow drainage water to enter during the rain periods but will also pull air from areas near expressways and other sources of pollution. This air is pulled in by creating a low pressure zone in the covered drain channels using a highly powered aircraft type jet engine, a turboprop type, or other appropriate engine driving a suction fan. The recovered air is passed through a revolving disc screen filter which extracts any entrained particles and refuse which is then collected in a suitable bin. The air then passes into a purifier using a suitable combination of electrostatic, chemical, absorptive, and other techniques before ultimately being discharged to the atmosphere. The power control for the system will be computerized for optimum operation with various input data, of pollution levels, wind conditions and other parameters including cost/benefit estimates.” The present invention incorporates these and other teachings of Blikken '693.

WO 97/38570, PCT/US96/05121, 15 Apr. 1996 to Daniel S. Redford (Redford '38570) teaches of (Abstract) “An atmospheric inversion layer de-stabilizer apparatus is using the energy of the water vapor present in the earth's atmosphere to de-stabilize an atmospheric inversion layer, as a way to disperse the air pollutants concentrated below the inversion layer, in time to prevent photochemical reactions and smog formation. The apparatus may also be used to alleviate frost, disperse fog, and control the atmosphere's composition above of a limited geographic area. The apparatus is using a ring balloon (26) filled with lighter than air gas, to elevate vertically in the atmosphere an air transport shuttle (42), and a control platform (122) to control the altitude and the ascending and descending speed of the air transport shuttle (42) via a vertical cable (102) attached to the air transport shuttle (42) and wounded on a motorized reel (146).” Redford '38570 is one of the very few examples of present art addressing public-sector-type approaches to air pollution mitigation.

The present invention utilizes the teachings of U.S. Pat. No. 6,792,259 to Parise (Parise '259), entitled “Remote Power Communication System and Method Thereof”. Parise '259 teaches that (col. 1, line 20) “There have been numerous attempts and initiatives established for next generation land based vehicles. Federal and local governments have placed limits on emissions as well as set standards for fuel consumption. Some programs have set goals for vehicle mileage of 80 miles per gallon and greatly reduced vehicle emissions based on today's standards. Even with recapture of regenerative braking energy, a hybrid electric/internal combustion vehicle will be hard pressed to meet these goals.” (col. 1, line 29) “One of the major causes of smog today is the use of city buses for public transportation. Diesel and gasoline driven buses spew out tons of pollutants daily.” The present invention incorporates these and other teachings of Parise '259.

b) Unlike the prior art public-sector air-pollution prevention-mitigation aforementioned, prior art public-sector light-pollution and noise-pollution prevention-mitigation is wide and deep. Examples of public-sector light-pollution prevention-mitigation include U.S. Pat. No. 4,231,080 to Compton, U.S. Pat. No. 4,864,476 to Lemons, et al., U.S. Pat. No. 5,329,438 to Thompson, and U.S. Pat. No. 6,676,279 and U.S. Pat. No. 6,705,744 to Hubbell, et al. Examples of public-sector noise-pollution prevention-mitigation include U.S. Pat. No. 3,983,956 to Manhart, U.S. Pat. No. 4,358,090 to Glaesener, U.S. Pat. No. 4,674,593 to McCarty and U.S. Pat. No. 4,899,498 to Grieb.

The present invention utilizes the teachings of U.S. Pat. No. 4,231,080 to Compton (Compton '080). Compton '080 teaches that (col. 1, line 10) “It is an objective of conventional luminaires to provide a relatively uniform illumination over a substantial area on the ground, and at the same time to cut off light above a given vertical angle. The latter reduces light pollution. This is an unexpectedly difficult problem to solve, especially in a compact luminaire of sensibly small size, and even more so when the luminaire must be located close to the ground where a relatively high maximum vertical angle of intensity is desirable.”

The present invention utilizes the teachings of U.S. Pat. No. 4,864,476 to Lemons, et al. (Lemons '476). Lemons '476 teaches that (col. 1, line 30) “Areas being illuminated are often located in residential or relatively high population density areas, and the lighting of an athletic field is often objected to by nearby residents due to the light pollution occurring resulting from light ‘spillage.’” (col. 1, line 36) “It is known to endeavor to uniformly illuminate athletic fields by the use of luminaire reflectors, shields, lenses, screens and the like wherein attempts are made to focus the light in a desired direction. Prior art systems have not successfully provided efficient uniform illumination over relatively large areas with a minimum of light spillage, and often, where a high degree of illumination is required, the lighting systems are “over-designed” producing “hot spots” and sacrificing efficiency of operation. Further, many lighting systems for athletic fields are not capable of adequately confining the projected light resulting in the creation of light pollution and ill feelings by neighbors due to light spillage.”

The present invention utilizes the teachings of U.S. Pat. No. 5,329,438 to Thompson (Thompson '438). Thompson '438 teaches of (col. 1, line 5) “ . . . a light impermeable reflector for roadway use with a head fixture housing bearing a depending light source improving spread and uniformity and reducing glare avoiding light pollution of the night sky.” (col. 1, line 32) “The problem of light pollution of the night sky has attracted the attention of environmental organizations. Glare is another problem common to outdoor roadway lighting luminaire.”

The present invention utilizes the teachings of U.S. Pat. No. 6,676,279 ('279) and U.S. Pat. No. 6,705,744 ('744) to Hubbell, et al. (a co-inventor of the present invention). Patents '279 and '744 teach that prior art systems for illuminating large, distant areas generally are deficient in that they produce light pollution, confusing night time driving conditions, light trespass, glare, energy waste, high maintenance cost and contribution to urban sky glow. The present invention is directed to a need to provide an area lighting and/or other wavelength radiation device that avoids the shortcomings of the prior art lighting systems.”

The present invention utilizes the teachings of U.S. Pat. No. 3,983,956 to Manhart (Manhart '956). Manhart '956 teaches that (col. 1, line 12) “Federal and State legislative bodies have recognized the widespread problem of traffic noise in adjacent communities and the result has been the establishment of mandatory noise control measures for existing and future highways. To meet the traffic noise levels that are compatible with different land uses requires substantial noise abatement efforts on a large number of highways.” (col. 1, line 20) “One method of achieving lower community noise levels is by the use of a noise reduction barrier. Such a barrier attenuates noise by preventing the direct propagation of noise between the noise source and the listener, and also, in many cases, by absorbing the sound energy incident upon the surface of the barrier. Barriers are applicable to the design of new highways and are an attractive means of providing noise relief to communities along existing highways.” Manhart '956 summaries that (col. 1, line 29) “There are four primary requirements for an acceptable highway noise barrier: a. it must function effectively as a noise reduction structure b. the barrier must be a safe roadside structure c. the total installation cost must be acceptable, and d. the barrier must have an acceptable appearance.” (col. 1, line 65) “The ability of a barrier to reduce noise levels in specific areas, depends upon a number of variables including geometrical factors such as the relative heights and distances of the noise source and receiver to the barrier, and the impervious mass per unit area (i.e., surface density) of a wall type barrier.” The present invention incorporates these and other teachings of Manhart '956.

The present invention utilizes the teachings of U.S. Pat. No. 4,358,090 to Glaesener (Glaesener '090). Glaesener '090 teaches that (col. 1, line 19) “As highways increasingly are compelled to traverse residential areas, hospital zones and even industrial areas in which silence is a virtue, a problem arises with respect to the noise generated by the vehicles traveling on such highways. The problem is particularly pronounced as vehicle size increases and vehicle speed increases both for heavy vehicles and light vehicles.” (col. 1, line 26) “Not only does the sound generated by traveling vehicles rank as an inconvenience to neighbors of such highways, but there is increasing evidence that continuous high noise levels associated with vehicle travel are detrimental to the health of individuals who dwell or work in the vicinity of highways, throughways, heavily traveled streets and avenues, and even carparks where both engine starting and wheel noise may be significant.” (col. 1, line 34) “Consequently, proposals have been made to limit the transmission of sound (usually noise) from a vehicle area, e.g. a highway, to adjoining areas involving sound barriers which can be placed along the edges of the street or highway.” (col. 1, line 39) “It is a common practice to flank the traveling lanes or shoulders of highways and streets with wheel-engaging barriers of small height, generally less than the diameter of an ordinary automobile wheel, to serve as a safety guide or the like. Such safety barriers may be in the form of curbs or simple ridges which flank the road or street.” (col. 1, line 51) “In these road barriers, guide strips or planks of considerable length and hence significant transverse flexibility, are spaced above the ground and span spaced apart posts and are intended to guide the vehicle back into a travel lane without excessive rebounding or damage to the vehicle.” (col. 1, line 57) “In the erection of such structures, the fabrication of new highways, the rebuilding of old highways and application of safety devices including vehicle-guide barriers to existing highways, it is desirable to consider all aspects of the problem, namely, the desire to provide effective road barriers and to provide acoustic barriers where required. Naturally, the current technique of providing sound barriers in addition to existing safety barriers is expensive but perhaps more important is the fact that in many cases there is insufficient room for both safety barriers and acoustic barriers so that a sound-blocking solution frequently results in an unsatisfactory safety level and vice versa. An alternative, of course, is to increase the width of the highway, frequently at prohibitive cost, and the right of way associated therewith.” The present invention incorporates these and other teachings of Glaesener '090.

The present invention utilizes the teachings of U.S. Pat. No. 4,674,593 to McCarty (McCarty '593). McCarty '593 teaches that (col. 1, line 10) “It is well recognized that noise in some cases has become a major problem in this country. This is particularly true along freeways that go through residential areas. Various means have been devised to attempt to reduce the noise level in such protected areas as the residential areas. Such means includes erecting masonry walls of stone or brick or concrete six to ten feet in height and also the planting of shrubbery such as small trees between the noise making area and the protected area. Although this has been of some help, it does not give the protection or the noise reduction that is desired. For example, it is believed that these prior art methods reduce the noise level not over about 40% at best.” The present invention incorporates these and other teachings of McCarty '593.

The present invention utilizes the teachings of U.S. Pat. No. 4,899,498 to Grieb (Grieb '498). Grieb '498 teaches that (col. 1, line 19) “It is well recognized that noise has become a major environmental problem. This is particularly true along freeways that pass through residential areas. On-going efforts have been made to attempt to reduce the noise level by the construction of sound barriers along the freeways. Such barriers have included both masonry walls of stone, brick or concrete, six to ten feet in height, and also wood planking and, in some instances, berms with shrubbery planted on the berms to defuse the noise. Although this has been of some help, it does not provide the protection from the noise that is desired. This is due to the use of materials such as masonry, brick or concrete which are not sound absorbing materials and only reflect the noise. Wood planking has also been used but is also solid and has limited sound absorbing capability.” The present invention incorporates these and other teachings of Grieb '498.

c) The prior art is very extensive in means and methods, devices in the use of catalyses in addressing needs associated with pollution in general and fluids pollution in particular. While the below presented prior art review is focused on the use of titanium-dioxide and like catalytic designs the reader will recognize that where appropriate the terms titanium-dioxide or photo-catalysis could be substituted with any number and/or combination of appropriate catalyses. For example, U.S. Pat. No. 1,789,812 to Frazer teaches of (page 1, line 8) “Various attempts . . . to eliminate carbon monoxide from the products of combustion of internal combustion engines . . . ” and the use of zinc-chromite as a catalysis. As the present invention's preferred embodiment utilizes titanium-dioxide as the preferred photo-catalysis, the focus of the review will be the substantial prior art in the uses of titanium-dioxide and like catalytic designs. Examples included are U.S. Pat. No. 3,067,115 to Clingman, Jr., U.S. Pat. No. 4,684,537 to Graetzel, et al., U.S. Pat. No. 4,750,917 to Fujii, U.S. Pat. No. 4,751,005 to Mitsui, et al., U.S. Pat. No. 4,788,038 to Matsunaga, U.S. Pat. No. 4,806,514 to Langford, et al., U.S. Pat. No. 4,861,484 to Lichtin, et al., U.S. Pat. No. 4,863,608 to Kawai, et al., U.S. Pat. No. 4,892,712 to Robertson, et al., U.S. Pat. No. 4,966,665 to Ibusuki, et al., U.S. Pat. No. 4,997,576 to Heller, et al., U.S. Pat. No. 5,045,288 to Raupp, et al., U.S. Pat. No. 5,069,885 to Ritchie, U.S. Pat. No. 5,126,111 to Al-Ekabi, et al., U.S. Pat. No. 5,252,190 to Sekiguchi, et al., U.S. Pat. No. 5,449,443 to Jacoby, et al., U.S. Pat. No. 5,501,801 to Zhang, et al., U.S. Pat. No. 5,689,798 to Oeste, and U.S. Pat. No. 5,779,912 to Gonzalez-Martin, et al.,

The present invention utilizes the teachings of U.S. Pat. No. 3,067,115 to Clingman, Jr. (Clingman, Jr. '115). Clingman, Jr. '115 teaches of (col. 1, line 9) “ . . . increasing efficiency of reactions induced by ionizing radiation . . . ” (col. 1, line 39) “In many chemical reactions, and particularly organic chemical reactions, at the severities under which they are normally carried out, undesirable side products are formed due to the environmental conditions under which the reactions are carried out.” (col. 3, line 42) “The n-type semiconductors useful in this invention are the solid n-type semiconductors, such as zinc oxide, which are known to the art. The n-type semiconductor solid absorbs high energy radiation and converts it into low energy excited electrons within the solid. The low energy excited electrons then promote the hydrocarbon oxidation reaction on the surface of the solid.” (col. 3, line 56) “The electrons in any solid are excited into higher energy levels by radiation but in most cases the excited electrons revert back to the ground state so rapidly that they never reach the solid surface. In the solids useful in the present invention the excited electrons have a long enough lifetime so that they can enter into such surface reactions and do not so rapidly revert to the ground state. The useful solids are found among the salts of the metals in groups II through VIII of the periodic table. The solid is a n-type semiconductor such as zinc sulfide, ferric oxide, cadmium sulfide, titanium oxide, lead oxide, tungsten oxide and, in particular, zinc oxide is preferred. The n-type semi-conductor may contain impurities or other metal salts, for example, zinc oxide containing small amounts of Al₂O₃.” (col. 4, line 42) “In carrying out the present invention, it has been found that the solid becomes poisoned by deposits of water and other oxidation products on the converter surface. Therefore, it is preferred to continually remove such by-products and particularly water from the surface. If a fixed bed of n-type semiconductor solid is used, the water may conveniently be continually removed by flowing the reactants over the bed at a temperature range between 70O and 150O C. to remove the water by evaporation. If a fluidized body of solid is employed, the fluidized solid may be passed through the regeneration zone where the water may be stripped from the solid surface with an air stream at elevated temperature. It has been found that regenerating the n-type semiconductor solid by dehydration increases the efficiency of the solid as much as three times.” (col. 4, line 59) “A regenerated solid has further been found to be more active than fresh solid and it is therefore advantageous to dehydrate even fresh solid for increased efficiency.” The present invention incorporates these and other teachings of Clingman, Jr. '115.

The present invention utilizes the teachings of U.S. Pat. No. 4,684,537 to Graetzel, et al. (Graetzel '537). Graetzel '537 teaches of (col. 1, line 24) “ . . . the problems of the efficiency of solar energy conversion in applications such as the photodecomposition of aqueous liquids, it would be of interest to possess photocatalysts having a light absorption band in or near the visible region. It has been observed that, by forming a complex of titanium oxide (TiO2) using a complex of titanium and 8-hydroxyquinoline, it is possible to sensitize the particles of titanium oxide so as to enable them to be used in visible light [see in this connection J. Am. Chem. Soc. 105, 5695 (1983)].” The present invention incorporates these and other teachings of Graetzel '537.

The present invention utilizes the teachings of U.S. Pat. No. 4,750,917 to Fujii (Fujii '917). Fujii '917 teaches of (col. 1, line 48) “ . . . an air cleaning system by irradiation of ultraviolet rays (Japanese Patent Application No. 216293/1984). Such a system is effective for a certain application field and utility, but is insufficient if applied to the purification of air containing ultrafine particles and any special field.” (col. 3, line 47) “ . . . the metal surface 21 may be any which generates photo-electrons by the irradiation of the ultraviolet rays, which is more preferable if having smaller photo-electric work function. From the point of view of both advantage and economy, any of Ba, Sr, Ca, Y, Gd, La, Ce, Nd, Th, Pr, Be, Zr, Fe, Ni, Zn, Cu, Ag, Pt, Cd, Pb, Al, C, Mg, Au, In, Bi, Nb, Si, Ta, Ti, Sn and P or compounds or alloys of them are preferable, and may be used solely or in combination of two or more of them. As a composite material, a physical composite material like amalgam may be employed.” The present invention incorporates these and other teachings of Fujii '917.

The present invention utilizes the teachings of U.S. Pat. No. 4,751,005 to Mitsui, et al. (Mitsui '005). Mitsui '005 teaches of (col. 1, line 7) “ . . . a method for the treatment of waste water. Particularly, it relates to a method for effecting wet oxidation of waste water containing a substance of chemical oxygen demand (hereinafter referred to as “COD component”) in the presence of a catalyst. More particularly, it relates to a method for effectively detoxifying waste water containing a COD component, i.e. a harmful oxidizable organic or inorganic substance, by subjecting the waste water to catalytically wet oxidation in the presence of molecular oxygen thereby converting the harmful substance into such harmless compounds as carbon dioxide, water, and nitrogen.” (col. 1, line 47) “Among the catalysts heretofore used popularly in the catalytically wet oxidation method, there are counted compounds of such noble metals as palladium and platinum (Japanese Patent Laid-Open No. SHO 49(1974)-44,556) and compounds of such heavy metals as cobalt and iron (Japanese Patent Laid-Open No. SHO 49(1974)-94,157). They are catalysts which have the compounds deposited on spherical or cylinderical carriers of alumina, silica-alumina, silica gel, and activated carbon. More often than not, in the catalystically wet oxidation of waste water, these catalysts are put to use in the reaction at a pH value of not less than 9. In our experiment, the catalysts, in the course of their protracted use, have been found to suffer from loss of strength and disintegration of individual particles and, in an extreme case, entail dissolution of their carrier.” (col. 1, line 63) “In an effort to solve this problem, there have been recently proposed methods for reinforcing the catalysts by using titania or zirconia as a carrier therefor (Japanese Patent Laid-Open Nos. SHO 58(1983)-64,188 and SHO 59(1984)-19757). To be specific, these inventions disclose catalysts which have compounds of such noble metals as palladium and platinum or compounds of such heavy metals as iron and cobalt deposited on spherical or cylindrical carrier particles of titania or zirconia. By experiment, the carriers are certainly found to possess greater strength than the conventional carriers. These catalysts, however, are invariably in a particulate form. Moreover, they are not fully satisfactory in terms of catalytic activity and durability.” (col. 4, line 8) “The catalyst contemplated by the present invention is characterized by using as a catalytic component thereof a binary composite oxide comprising titanium and silicon (hereinafter referred to as “TiO2—ZrO2”), a binary composite oxide comprising titanium and zirconium (hereinafter referred to as “TiO2—ZrO2”), a binary composite oxide comprising zirconium and silicon (hereinafter referred to as “ZrO2—SiO2”), or a ternary composite oxide comprising titanium, silicon, and zirconium (hereinafter referred to as “TiO2—SiO2—ZrO2”).” (col. 4, line 18) “Generally, the binary composite oxide comprising titanium, and silicon, from the report of Kozo Tanabe “Catalyst,” Vol. 17, No. 3, page 72 (1975), has been widely known as a solid acid. It exhibits conspicuous acidity not found in either of the component oxides thereof and possesses a large surface area.” (col. 4, line 24) “The TiO2—SiO2 is not a mere mixture of titanium dioxide with silicon dioxide but is a product which is inferred to manifest the peculiar physical attributes mentioned above because titanium, and silicon are combined to form the so-called binary type oxide. Further, the binary composite oxide containing titanium and zirconium, the binary composite oxide containing zirconium and silicon, and the ternary composite oxide containing titanium, zirconium and silicon are characterized as composite oxides possessing the same qualities as TiO2—SiO2” (col. 4, line 59) “The catalyst component A of the catalyst used in this invention, i.e. one member selected from the group consisting of TiO2 . . . ” (col. 5, line 21) “The ratio of the catalyst components making up the catalyst to be used in this invention is desirably such that the proportion of the catalyst component A falls in the range of 75 to 99.95% by weight as oxide and the catalyst component A falls in the range of 0.05 to 25% by weight as metal or compound.” The present invention incorporates these and other teachings of Mitsui '005.

The present invention utilizes the teachings of U.S. Pat. No. 4,788,038 to Matsunaga (Matsunaga '038). Matsunaga '038 teaches of (col. 1, line 8) “ . . . a new and useful process for killing various cells utilizing the voltage generated in a photosemiconductor.” (col. 1, line 13) “The application of germicides, heat and the like has been commonly practiced in order to kill various kinds of cells such as bacteria, microscopic algae, blood corpuscles, and animal and plant cells.” (col. 1, line 17) “In the treatment of foodstuffs, pharmaceuticals, and various animals and plants, however, these processes have often produced undesirable effects such as denaturation of the material and side effects.” The Matsunaga '038 device (col. 1, line 63) “ . . . provides a method for killing cells characterized by bringing a material containing living cells into contact with a non-conductor-carrying photosemiconductor material or a cytocidal agent containing this material, and killing the living cells by the irradiation of light to the non-conductor-carrying photosemiconductor. Upon irradiation of the non-conductor-carrying photosemiconductor material, a voltage is generated in the semiconductor which is then applied to the cells to kill them.” The Matsunaga '038 device (col. 2, line 26) “ . . . is able to kill various microorganisms such as bacteria, actinomycetes, molds, microscopic algae and yeasts, animal cells such as red and white corpuscles, tumorous cells, and tissue-culture cells and plant cells.” (col. 2, line 33) “Although all semiconductor materials possess the Dember effect, the photoelectromotive force is proportional to the logarithm of the electron-positive hole mobility ratio, with the photoelectromotive force being “zero” when the logarithm is one. Accordingly, TiO2, RuO2, Cs3 Sb, InAs, InSb, and GaAs with relatively high electron-positive hole mobility ratios may be cited as suitable semiconductor materials for actual use.” The present invention incorporates these and other teachings of Matsunaga '038.

The present invention utilizes the teachings of U.S. Pat. No. 4,806,514 to Langford, et al. (Langford '514). Langford '514 teaches of (col. 1, line 7) “ . . . a composite photocatalyst for the photochemical degradation of refractory waste materials and to a method of using the photocatalyst for treating refractory waste materials which are known to withstand high temperature oxidation, such as chlorinated aromatic compounds and metal cyanide complexes, to degrade same. The invention is particularly directed to the detoxification of PCB's (polychlorinated biphenyls).” (col. 1, line 16) “Previous reports have described the dechlorination of PCB's involving a photocatalytic process using titanium dioxide. The scope of the potential for photocatalysis in waste treatment was reported in a paper by Carey and Oliver, Water Poll. Res. J. of Canada, Vol. 15, No. 2, 1980, pp. 157-185. In this report, the authors were able to demonstrate laboratory potential for all of the following reactions using titanium dioxide: 1 Oxidation of cyanide. 2. Decoloration of pulp mill black liquors. 3. Dechlorination of chlorobezoate to benzoate. 4. Increase of biodegradability of a lignin model. 5. Detoxification of AROCLOR 1254 (trademark; a polychlorinated biphenyl).” (col. 1, line 30) “Titanium dioxide has been the most popular of metal oxide semiconductors for study of photocatalysis for nearly 50 years. It has a band gap of 3.2 eV and absorbes light starting from 350 nm and continuing toward higher energy. Consequently, there has been continuing interest in methods for the sensitization of titanium dioxide to allow use of longer wavelength.” The present invention incorporates these and other teachings of Langford '514.

The present invention utilizes the teachings of U.S. Pat. No. 4,861,484 to Lichtin, et al. (Lichtin '484). Lichtin '484 teaches of (col. 4, line 30) “ . . . a catalytic process for the degradation of organic materials into environmentally compatible products, this process comprising the steps of: obtaining the organic material to be degraded in a water-containing fluid state; and combining the fluid organic material with a solid catalyst comprising at least one transition element and a peroxide as a reaction mixture in the presence of photoenergy absorbable by the solid catalyst to yield environmentally compatible reaction products comprising at least carbon dioxide.” (col. 3, line 68) “ . . . articles stating that some common, organic contaminants in water are completely mineralized in the presence of a titanium dioxide catalyst illuminated with near-ultraviolet light [Barbeni et al., Nouv. J. de Chim. 8: 547 (1984); Barbeni et al., Chemosphre 14: 195-208 (1985); Matthews, R. W., J. Catal. 97: 565 (1986) and Water Res. 20: 569-578 (1986)].” (col. 6, line 20)) “The catalytic process of the present invention is intended to be utilized at ambient temperature. It is expected that the ambient temperature will vary within the extremes considered normal in the temperate zone, that is, substantially in the range from 32.degree.-100.degree. F.” The present invention incorporates these and other teachings of Lichtin '484.

The present invention utilizes the teachings of U.S. Pat. No. 4,863,608 to Kawai, et al. (Kawai '608). Kawai '608 teaches of (col. 4, line 24) “ . . . a process for the preparation of ultra pure water from a source of water selected from the group consisting of city water, well water, industrial water and washings removed from rinsing steps of semiconductor wafers in integrated circuit manufacturing processes, which comprises two basic stages (a) and (b), the former stage (a) being for previously treating the raw water in one or more mechanical filtration steps to remove solid particulate contaminants suspended therein and the latter stage (b) being for producing ultra pure water from the pretreated water by a series of purification treatments consisting essentially of steps known for the removal of residual solid particulate contaminants, of ionic contaminants, of organic contaminants included in total organic carbon (TOC) content and of microorganisms from the pretreated water to produce ultra pure water, said purification steps being selected from, and combined together, reverse osmosis, adsorption on ion exchange resins, adsorption on activated carbon, ultrafiltration, UV sterilization, microfiltration and other equivalent treatments, characterized in that a catalytic photolysis step is incorporated into the stage (b) for decreasing the TOC content of the water being treated to a level lower than the minimum detection level of TOC detectors, the said step comprising irradiating the water to be so treated with a light of a wave length corresponding to an energy higher than the band gap of an inorganic semiconductor used as specified below in the presence of a catalytic amount of a photocatalyst comprising an inorganic semiconductor in fine particulate form selected from TiO2, SrTiO2 and CdS and a noble metal and/or oxide thereof selected from Pt, Pd, Ru, RuO2 and Rh deposited on said semiconductor particles for a period of time sufficient to oxidatively deompose the organic contaminants.” (col. 7, line 30) “Most typical examples, among others, of the photocatalysts usable for the purpose of this invention include TiO2/Pt, TiO2/Pt⁺ RuO2, TiO2/Pd, TiO2/Rh, SrTiO2/Pt and Cds/Pt.” (col. 8, line 67) “In practicing the process of this invention, the photocatalyst to be used in particular applications may be chosen depending mainly upon the nature and amount of organic contaminants to be decomposed and removed. Thus, TiO2 as the semiconductor component exhibits a very strong oxidative action as being capable of effecting oxidative decompostion of most of organic contaminants though it has not a so wide wavelength range of light available. The combination of Pt with TiO2 has been found to enhance much more the catalytic activity. The combination of CdS/Pt has a much wider wavelength range of light available than that of TiO2/Pt and is therefore advantageous in energic point of view.” The present invention incorporates these and other teachings of Kawai '608.

The present invention utilizes the teachings of U.S. Pat. No. 4,892,712 to Robertson, et al. (Robertson '712). Robertson '712 teaches that (col. 1, line 13) “It has been known for some time that titanium dioxide can achieve photodechlorination of PCB's, as described by J. H. Carey et al in “Photodechlorination of PCB's in the Presence of Titanium Dioxide in Aqueous Suspensions”, Bulletin of Environmental Contamination & Toxicology, Vol 16, No. 6, pp. 697-701, 1976 Springer-Verlag New York Inc. Carey et al describe irradiation by ultra violet light with a wavelength of 365 nm of a 25 ppb aqueous solution of Aroclor 1254* (*Trade Mark) in the presence of suspended particulate titanium dioxide After 30 min. no unreacted Aroclor could be detected in solution or adsorbed on the surface of the TiO2. Similar experiments were conducted with other PCB's and resulted in an observed disappearance of the chlorinated biphenyls and the production of chloride ions.” (col. 1, line 29) “R. W. Matthews has reported the conversion (often called “mineralization”) of a number of organic compounds to carbon dioxide by exposure to near ultra violet light in aqueous suspensions of anatase, a form of crystalline titanium dioxide. The solutes studied were benzene, benzoic acid, benzoate ion, salicylate ion, phenol, chlorobenzene, aniline, anilinium ion, nitrobenzene, chloroform and formic acid (“Carbon Dioxide Formation from Organic Solutes in Aqueous Suspensions of Ultraviolet-Irradiated TiO2. Effect of Solute Concentration” by R. W. Matthews, Aust. J. Chem., 1987, 40,001-000, pp 1-9). The same author had earlier reported similar results with benzoic acid or sodium benzoate (“Hydroxylation Reactions Induced by Near Ultraviolet Photolysis of Aqueous Titanium Dioxide Suspensions,” J. Chem. Soc. Faraday Trans. 1, 1984, 80, pp 457-471).” (col. 1, line 46) “Chen-Yung Hsiao et al have also reported the mineralization of chloromethanes to CO₂ and HCl by the heterogeneous photocatalyst TiO2 (“Heterogeneous Photocatalysis:Degradation of Dilute Solutions of Dichloromethane (CH₂Cl₂), Chloroform (CHCl₃), and Carbon Tetrachloride (CCl4) with Illuminated TiO2 Photocatalyst,” Journal of Catalysis 82, 1983, pp 418-423).” (col. 1, line 54) “Similar reactions have not been limited to TiO2. Other metal semiconductors, such as ZnO, CdS, WO3 and SnO2, have been utilized in photocatalytic processes for the degradation of environmental contaminants (“Photocatalysis Over TiO.sub.2 Supported On A Glass Substrate,” by N. Serpone et al, Solar Energy Materials 14 (1986) pp 121-127, Elsevier Science Publishers B.V.-North-Holland Physics Publishing Divisions, Amsterdam).” (col. 2, line 3) “Most of the laboratory reactions discussed in the literature referred to above involve forming a suspension of particulate TiO2 (or other metal semiconductors) in the water containing the organic pollutants that are to be converted into harmless by-products. This procedure is impracticable for the commercial purification of water, because the particulate TiO2 would have to be subsequently removed before the water could be used, and this would be either impossible or prohibitively expensive.” (col. 2, line 13) “In its preferred form, the present invention solves this problem by firmly bonding the TiO2 or other metal semiconductor (subsequently referred to as the “photoreactive material”) with, to or into surfaces of a substrate that has the properties of a large surface area for coating with the photoreactive material, a porous construction such that the fluid to be treated can thoroughly contact the coated surfaces, and sufficient transparency to light at a wavelength to which the photoreactive material photoreacts to ensure that all the coated surfaces receive such light at an adequate energy level to ensure the catalytic or photoreactive effect.” (col. 1, line 25) “The bonding of the photoreactive material to the substrate must be so firm that no appreciable amount of it enters the fluid.” The present invention incorporates these and other teachings of Robertson '712.

The present invention utilizes the teachings of U.S. Pat. No. 4,966,665 to Ibusuki, et al. (Ibusuki '665). Ibusuki '665 teaches that (col. 2, line 51) “ . . . volatile chlorine-containing organic compound can be rapidly decomposed with a high efficiency even when the concentration thereof in the vent gas is so low as not to ensure efficient adsorption by any adsorbent materials. In addition, the catalytic activity of the titanium dioxide powder for the photochemical decomposition is very durable and safe from gradual decrease in a continued running. The troublesome and time consuming step of regeneration of the adsorbent indispensable in the prior art adsorption method is of no use in the inventive method. Further, the source of the ultraviolet light can be a conventional and inexpensive lamp provided that the lamp emits a light in a wavelengt of 400 nm or shorter so that natural sun light or so-called black light lamps emitting light mainly at a wavelength of 360 nm can be used satisfactorily and the costs for the expensive ozone-generating lamps in the prior art can be saved.” The present invention incorporates these and other teachings of Ibusuki '665.

The present invention utilizes the teachings of U.S. Pat. No. 4,997,576 to Heller, et al. (Heller '576). Heller '576 teaches that (col. 5, line 17) “TiO2 pigment particles having diameter on the order of 30-200 nm. TiO2 (rutile) or TiO2 (anatase) are particularly preferred for use in this invention, as they are widely used white pigments, and are well known as photocatalysts in the oxidation of contacting organic compounds. Both are substantially nontoxic and environmentally harmless. Both are n-type semiconductors with 3 eV and 3.3 eV band gaps, respectively. The high index of refraction (n=2.8) that makes TiO2 (rutile) an excellent light scatterer also makes it a good collector of photons in the present system.” (col. 5, line 28) “There is a great amount of literature on photoassisted (i.e. photocatalytic) oxidations with TiO2. It has been theorized that absorption of a photon by TiO2 produces an electron-hole pair. The photogenerated holes oxidize directly contacting organic compounds. The electrons reduce oxygen to a surface-bound peroxide, that also photooxidizes organic compounds.” The present invention incorporates these and other teachings of Heller '576.

The present invention utilizes the teachings of U.S. Pat. No. 5,045,288 to Raupp, et al. (Raupp '288). Raupp '288 teaches that (col. 1, line 15) “The future availability of groundwater as a source of potable water is being jeopardized by the widespread occurrence of organic contaminants in groundwater supplies. A variety of pollutants have been detected, but none occur more frequently or at higher concentrations than trichloroethylene (TCE), a volatile organic compound (VOC) classified as a probable human carcinogen (Dyksen and Hess 1982). Remedial strategies now in widespread use for treating VOC-polluted groundwaters do not destroy contaminants during treatment, but instead merely shift the pollutants to another medium. For example, aeration produces contaminated air streams which are usually vented directly to the atmosphere, while activated carbon adsorption produces hazardous solid wastes. Efforts to manage polluted groundwater through well abandonment and blending contaminated water with clean water to meet standards are not viable long term options in a water limited environment, where all available resources must be utilized fully.” The Raupp '288 device provides the (col. 1, line 58) “ . . . means and methods for removing harmful groundwater pollutants of volatile and non-volatile organic compounds such as trichloroethylene (TCE), polychlorinated biphenyls (PCBs) and the like, and destroying the pollutants or otherwise converting them into environmentally innocuous species. The present invention achieves this socially needed objective by the unique application of gas-solid heterogeneous photocatalytic oxidation to the removal of such pollutants from heretofore unusable groundwater and converting that groundwater to useful potable water inventories without producing alternative form environmental hazards.” (col. 2, line 3) “This great human benefit is realized by processing polluted water supplies with ultraviolet illuminated titanium dioxide in combination with a fluidized bed photo reactor formed of optical quality glass (boro-silicate), quartz or like substances which are transparent to light waves having a wave length of less than 450 nanometers (ultraviolet).” (col. 2, line 10) “Gas-solid photocatalytic oxidation with UV-illuminated titanium dioxide has been found to overcome the separation problem inherent in prior aqueous work by utilizing a solid catalyst to achieve the destruction of TCE contained in a gas-phase carrier stream typical of the effluent produced by water treatment facilities. As will hereinafter appear in detail, this unique methodology results in the complete destruction of volatile organic water pollutants, and overcomes the previously inherent requirement to accept those pollutants in the environment as contaminated air streams or spent carbon beds.” The present invention incorporates these and other teachings of Raupp '288.

The present invention utilizes the teachings of U.S. Pat. No. 5,069,885 to Ritchie (Ritchie '885). Ritchie '885 teaches that (col. 1, line 14) “For some time it has been known that, in the presence of certain wavelengths of light, titanium dioxide and certain other semiconductors can achieve photodechlorination of PCBs. U.S. Pat. No. 4,892,712 (Robertson et al) summarizes the prior art, referring to publications by Carey et al, Chen-Yung Hsiao et al, Matthews, and Serpone et al.” (col. 1, line 60) “In all of the prior art, either the TiO2 (or other semiconductor) must be in suspension in the fluid in transparent tubing, or the substrates to which the semiconductor is bound must be transparent to light, in order for the photoactive materials to be exposed.” Ritchie '885 teaches to (col. 1, line 61) “ . . . avoid the above mentioned drawbacks of the prior art. More specifically, it is an object to provide apparatus which achieves the desired results with the TiO2 being immobilized on a substrate, but without requiring that the substrate be transparent.” (col. 1, line 66) “When exposed to ultraviolet light, titanium dioxide (particularly anatase) as well as certain other semiconductors, eject electrons from their lattices, creating positive holes (H+). The emitted electrons and holes created in the TiO.sub.2 lattice can either react with the organic pollutants in solution or they can recombine. In order to minimize the recombination and maximize the reaction it is necessary to ensure rapid mixing of the fluid to keep the surface coating of anatase supplied with fresh reactants. The supporting substrate must therefore be in a form suitable to create the necessary turbulent mixing as the fluid passes in order to break the boundary layer typically associated with a fluid passing over a surface, and to provide the reaction sites with fresh reactants.” The Ritchie '885 device provides that (col. 2, line 22) “ . . . the substrate need not be transparent in material or structure, because the placement of the substrate enables light to penetrate to the outer layers.” (col. 2, line 31) “With this structure, light radiating outwardly in all directions from the lamp wall strikes both flat surfaces of the “blades” of the substrate simultaneously. The helical configuration of the present invention does not in itself form a self-contained, fluid carrying channel. Only by enclosing the helix within a cylindrical jacket of an internal diameter similar to the outside diameter of the helix, will a channel be formed.” The present invention incorporates these and other teachings of Ritchie '885.

The present invention utilizes the teachings of U.S. Pat. No. 5,126,111 to Al-Ekabi, et al. (Al-Ekabi '111). Al-Ekabi '111 teaches of (col. 1, line 65) “U.S. Pat. No. 4,892,712 issued Jan. 9, 1990 (Canadian patent application No. 576,139 filed Aug. 31, 1988) . . . this prior patent (the contents of which are incorporated herein by reference) discloses a method of removing, reducing or detoxifying organic pollutants from a fluid, especially water, by bringing such fluid into contact with a photoreactive metal semiconductor material, preferably TiO2 in its anatase crystalline form, in the presence of ultraviolet light of a wavelength to activate such material. More specifically, this patent discloses a jacket, a lamp, and a photocatalytic sleeve. The lamp emits ultraviolet light in the 300-400 nm range and is mounted coaxially within the jacket. Around the lamp lies a sleeve matrix formed of fibreglass mesh that is coated with titanium dioxide (anatase). The anatase is activated by ultraviolet light.” The present invention incorporates these and other teachings of Al-Ekabi '111.

The present invention utilizes the teachings of U.S. Pat. No. 5,252,190 to Sekiguchi, et al. (Sekiguchi '190). Sekiguchi '190 teaches that (col. 1, line 13) “Bad smells and irritating smells generated in industries, smells emitted by wastes generated at homes and restaurants, and bad smells and irritating smells generated in cooking have become a bigger problem in recent years. These smells are composed mainly of hydrogen sulfide, ammonia, mercaptans, amines, aldehydes, etc.” (col. 2, line 1) “ . . . it is generally known that metal alkoxides can be produced from most of the metals listed in the periodic table [“Kogyo Zairyo (Industrial Materials)”, Vol. 29, No. 5, pp. 85-89, 1989, published by the Nikkan Kogyo Shimbun, Ltd.], preferred in the present invention are alkoxides of the elements of groups IIa, IIb, IIIa, IIIb, IVa, IVb, Va, Vb and VIII of the short form of the periodic table, particularly alkoxides of aluminum, silicon, titanium, zinc and zirconium, in view of their chemical stability and availability.” The present invention incorporates these and other teachings of Sekiguchi '190.

The present invention utilizes the teachings of U.S. Pat. No. 5,449,443 to Jacoby, et al. (Jacoby '443). Jacoby '443 teaches that (col. 1, line 20) “Conventional technology is very effective in removing particles from air. However, conventional technology is not able to remove solvents such as alcohols, ketones, halogenated ethylenes, halogenated ethanes, halogenated methanes, surfactants, photoresist solvents, etc. which are used in large quantities for cleaning and other manufacturing processes in all manufacturing environments, for example, a clean room environment. In a clean room, besides being hazardous to worker's health, these chemicals are able to deposit from the air onto “clean” high energy surfaces such as ceramic substrates, semiconductor surfaces, and metal surfaces. Whenever such chemicals deposit on such surfaces, they contaminate the surfaces. This can, and often does, result in ruined materials which must be scrapped if they cannot be readily cleaned. Organic pollutants and bioaerosols also affect the health and comfort of the occupants of commercial and residential buildings.” Jacoby '443 references (col. 1, line 38) “U.S. Pat. No. 4,666,478 . . . ” to Boissinot, (col. 1, line 45) “U.S. Pat. No. 4,863,608 . . . ” to Kawai et al., (col. 1, line 53) “U.S. Pat. No. 4,750,917 . . . ” to Fujii et al., (col. 1, line 58) “U.S. Pat. No. 5,152,814 . . . ” to Nelson, (col. 1, line 62) “U.S. Pat. No. 5,225,167 . . . ” to Wetzel, (col. 1, line 67) “U.S. Pat. No. 4,774,026 . . . ” to Kitamori, (col. 2, line 7) “U.S. Pat. No. 5,122,165 . . . ” to Wang, (col. 2, line 13) “U.S. Pat. No. 4,788,038 . . . ” to Matsunaga, (col. 2, line 16) “U.S. Pat. No. 4,264,421 . . . ” to Bard, (col. 2, line 17) “U.S. Pat. No. 4,303,486 . . . ” to Bard, (col. 2, line 20) “PCT WO 91/04094 . . . ” to Raupp, (col. 2, line 26) “European Patent Application Publication No. 0306301 . . . ” to Henderson, (col. 2, line 29) “U.S. Pat. No. 4,544,470 . . . ” to Herrick, (col. 2, line 32) “U.S. Pat. No. 4,861,484 . . . ” to Lichtin, (col. 2, line 37) “U.S. Pat. Nos. 4,888,101 and 5,118,422 . . . ” to Cooper, (col. 2, line 42) “U.S. Pat. Nos. 4,892,712 and 5,032,241 . . . ” to Robertson, (col. 2, line 46) “U.S. Pat. No. 4,943,357 . . . ” to Van Antwerp, (col. 2, line 50) “U.S. Pat. No. 4,954,465 . . . ” to Kawashima, (col. 2, line 53) “U.S. Pat. No. 5,035,784 . . . ” to Anderson, (col. 2, line 56) “U.S. Pat. No. 5,069,885 . . . ” to Ritchie, (col. 2, line 59) “U.S. Pat. No. 5,126,111 . . . ” Al-Ekabi, (col. 2, line 65) “U.S. Pat. No. 5,137,607 . . . ” to Anderson, (col. 3, line 1) “U.S. Pat. No. 5,144,146 . . . ” to Wekhof, (col. 3, line 4) “U.S. Pat. No. 5,174,877 . . . ” to Cooper, and (col. 3, line 7) “PCT Patent Publication WO 91/09823 . . . ” to Lichtin. The present invention incorporates these and other teachings of Jacoby '443.

The present invention utilizes the teachings of U.S. Pat. No. 5,501,801 to Zhang, et al. (Zhang '801). Zhang '801 teaches that (col. 1, line 48) “The primary oxidant responsible for the photocatalytic oxidation of organic compounds in aqueous solutions is believed to be the highly reactive hydroxyl radical (OH.), although direct reactions of adsorbed organic compounds with surface species such as holes have also been reported [Volz et al., 1981; Ceresa et al., Matthews, 1984; and Turchi and Ollis, 1990].” Zhang '801 references (col. 2, line 28) “U.S. Pat. No. 5,182,030 to Crittenden et al.”, (col. 2, line 38) “U.S. Pat. No. 4,863,608 to Kawai et al.”, and (col. 2, line 62) “U.S. Pat. No. 4,861,484 to Lichtin et al.” The present invention incorporates these and other teachings of Zhang '801.

The present invention utilizes the teachings of U.S. Pat. No. 5,689,798 to Oeste (Oeste '798) Oeste '798 teaches that (col. 1, line 26) “In the fixed-bed catalytic process, the catalyst carrier/catalyst system continuously or discontinuously passes through a washing zone to remove the generated mineralization products. The reaction is induced by shortwave photons of wavelengths between 250 and 400 nm. Endothermic chemical reactions require energy. Energy can be supplied in numerous ways. Frequently, photons of various wavelengths are employed. Since these reactions occur at relatively low temperatures, catalysts are added to accelerate the reaction. In the following, this combination of inducing chemical reactions by photons and increasing the speed of reactions by catalysts will be referred to as photocatalysis.” Oeste '798 references (col. 1, line 43) “Environmental Sci. Technol. Vol. 17, No. 10 (1983) 828-31, for . . . “an “ . . . example . . . ” of” . . . a reaction . . . in which chloroform is degraded in an aqueous suspension of titanium dioxide by photoassisted, heterogeneous catalysis” and (col. 1, line 54) “European Patent Application 89100265.1 discloses a method and apparatus for the removal of hydrogen sulfide from exhaust gases using a titanium dioxide catalyst applied on the surface of a honeycomb support of activated charcoal, and ultraviolet radiation.” and (col. 1, line 63) “ . . . German patent 40 23 995.0, a method is disclosed in which pollutants are photocatalytically mineralized by a fixed-bed catalyst which is moved relative to the photon source.” (col. 2, line 7) “Liquid or solid mineralization products such as phosphoric and arsenic acid, however, can accumulate on the photocatalyst if pollutants are continually employed which, in addition to carbon, hydrogen, oxygen, and nitrogen, contain, e.g., halogens, sulfur, phosphorus, or arsenic, as well as pollutants and other wastes consisting solely of these latter elements. The low reaction temperature, generally below 50.degree. C., does not allow these substances to evaporate. As a result, the photocatalytic function is increasingly inhibited, and the reaction finally stops completely.” The present invention incorporates these and other teachings of Oeste '798.

The present invention utilizes the teachings of U.S. Pat. No. 5,779,912 to Gonzalez-Martin, et al. (Gonzalez-Martin '912). Gonzalez-Martin '912 teaches of (col. 1, line 28) “Advanced oxidation processes (AOPs) typically involve treatment with ultraviolet light (UV), chemical oxidation, or both. AOPs are destructive processes in which the target organic compounds may be fully oxidized (i.e., mineralized) to relatively innocuous end products such as carbon dioxide, water, and inorganic salts. Because AOPs do not leave any residual contaminants requiring additional treatment, these processes are well suited for destruction of organic pollutants.” (col. 1, line 38) “Typical AOPs rely on the generation of hydroxyl radicals (OH*). The rapid, non-selective reactivity of OH* radicals (one of the most reactive free radicals and strongest oxidants) allows them to act as initiators of the oxidative degradation of organic contaminants.” (col. 1, line 45) “In the photocatalytic oxidation, TiO2/UV, the titanium dioxide semiconductor absorbs UV light and generates OH* radicals mainly from adsorbed water or OH— ions.” (col. 1, line 59) “Most of the photocatalytic studies on the degradation of organic pollutants have used TiO2 as the semiconductor. With TiO2, the overall oxidation reaction is mainly limited by O₂ reduction at cathodic sites on the semiconductor surface. Other factors affecting the efficiency of the process are the semiconductor surface area, catalytic properties of the semiconductor, and electron/hole recombination.” The present invention incorporates these and other teachings of Gonzalez-Martin '912.

d) Four reference examples of the availability of NHS site specific air turbulence from the present art are U.S. Pat. No. 5,272,378 to Wither, WO 02/066745 (PCT/IS01/00005), 19 Feb. 2001 to Jonsson, and U.S. Pat. No. 6,685,154 to Blyth et. al. (a co-invention of the present invention is a co-invention of Blyth et. al.) and Ser. No. 10/397,842 filed Mar. 27, 2003 to Hubbell et al. (a co-invention of the present invention is a co-invention of Hubbell et. al.).

The present invention utilizes the teachings of U.S. Pat. No. 5,272,378 to Wither (Wither '378). Wither '378 teaches of (col. 2, line 28) “An apparatus in accordance with preferred embodiments of the present invention is adapted for generating power by utilizing the wind produced from the passage of vehicular traffic.” (col. 2, line 53) “As vehicular traffic moves on both (i.e., opposite) sides of the support framework, the wind generated from the moving vehicles impinges the rotors, cooperatively causing them to rotate.” (col. 3, line 26) “Federal regulations and laws dictate that barriers be positioned between two oppositely directed lanes of traffic for such arteries as interstates and highways. As will become more apparent below, the apparatus of the present invention is designed to replace a conventional barrier with a barrier adapted to harness a heretofore untapped source of fuel. In this regard, the apparatus of the present invention is designed to be structurally sufficient to replace such conventional barriers.” The present invention incorporates these and other teachings of Wither '378. The inventors of the present invention are aware of the successful, full-scale, prototype testing conducted on Wither '378 devices confirming the viability of NHS vehicle generated wind energy.

The present invention utilizes the teachings of WO 02/066745 (PCT/IS01/00005), 19 Feb. 2001 to Jonsson and Hubbell (a co-inventor of the present invention), teaches that, in reference to the most commonly encountered highway guiderail system known in the industry as “W-beam”, (page 10, line 27) “Tests have shown that the present art's use of the W-beam is not aerodynamic and is a leading cause of airborne solids accumulation on roadway surfaces such as snow or sand. The present Invention provides for an aerodynamic shape to the rail component which minimizes accumulation on roadway surfaces of airborne solids.” (page 15, line 27) “The rail . . . and/or post . . . elements are shaped to address aerodynamic functions such as but not limited to increasing or decreasing wind velocities and/or wind direction. The aerodynamic function provides a means and method of encouraging or discouraging accumulation of fluid-bourne solids such as but not limited to wind-blown snow. The aerodynamic function also provides a means and method for direction and/or acceleration or deceleration of fluid-flow. Examples of fluid-flow direction and/or acceleration design application is the use of a generally transverse wind redirected AND/OR accelerated by the rail AND/OR post elements' aerodynamic design . . . to scour snow from road AND/OR bridge surfaces AND/OR building roofs. Positioned properly . . . the present Invention's rail . . . element can accelerate fluid-flow, such as air-mass, over the nearby surfaces thereby encouraging sublimation-of-ice, dissipation-of-previously-deposited-solids such as snow, and evaporation-of-standing-liquids such as water of driving surfaces.”

### OBJECTS AND SUMMARY OF THE INVENTION

It is, therefore, the principal object of the present invention to provide an effective solution to the problems outlined above.

It is an object of the present invention to provide discrete structural elements support of crystal catalyst elements such that significant surface areas of said crystalline structures remain available to interact with targeted, in fluid mass, undesired material, when such crystalline structures are exposed to undesired material and to degrade said undesired material into environmentally compatible products within said fluid mass.

It is another object of the present invention to provide mechanisms to maintain the aforesaid crystalline structure surfaces clearer or cleaner than otherwise so as to maintain the catalyst's physical presence with the aforesaid undesired material.

It is still another object of the invention to promote the movement of the aforesaid fluid mass so as to increase the incidences of the crystalline structure surfaces being in the physical presence of the targeted undesired material. (from Pro. Pat. '161).

It is yet another object of the invention to provide an efficient photocatalytic process and apparatus in which semiconductor catalyst is supported by discrete structural elements in a contaminated gaseous stream.

It is still another object of this invention to provide a process and apparatus wherein catalyst is secured to discrete structural elements and exposed to a contaminated gaseous stream and exposed to sunlight, indirect sunlight or reflected sunlight to convert organic compounds and other contaminants to innocuous byproducts.

Another object of this invention is to provide a safety barrier supporting catalyses elements, allowing said catalyses elements to degrade undesired material into environmentally compatible products within air masses moving past said catalyses elements, which occupies a minimum of space, is highly efficient for both safety and air pollution mitigation purposes and which is of comparatively low cost.

Another object of this invention is to provide a safety barrier supporting catalyses elements, allowing said catalyses elements to degrade undesired material into environmentally compatible products within air masses, accelerated by passing vehicles moving past said catalyses elements, which occupies a minimum of space, is highly efficient for both safety and air pollution mitigation purposes and which is of comparatively low cost.

Another object of the invention is to provide a safety barrier supporting catalyses elements, for highways or the like which can be erected rapidly and at low cost and is free from the disadvantages of earlier systems.

A principal object of the invention is to provide an economical and effective means for reducing the level of air pollution along highways.

A principal object of the invention is to provide an economical and effective means for reducing the level of air pollution along highways before such air pollution enters adjacent environs.

A more specific object of the invention is to provide safety barriers supporting catalyses elements which are readily mass produced.

A further object of the invention is to provide such safety barriers supporting catalyses elements which may be erected with a minimum of labor and material expense.

Other objects of the invention will in part be obvious and will in part appear hereinafter.

The invention accordingly comprises the features of construction, combination of elements, and arrangement of parts which will be exemplified in the construction hereinafter set forth, and the scope of the invention will be indicated in the claims.

### BRIEF DESCRIPTIONS OF THE DRAWINGS

FIG. 1 is a schematic perspective view of a cladded guardrail system.

FIG. 2 is an enlarged perspective view of FIG. 1

FIG. 3 is a schematic perspective view of a typical guardrail system.

FIG. 4 is a schematic perspective view of a typical roadside delineator post system.

FIG. 5 is a schematic perspective view of U.S. Federal Highway Administration (FHWA) National Cooperation Highway Research Program (NCHRP) 350 Test Level 3 galvanized steel W-beam highway guiderail system.

FIGS. 6A and 6B show another embodiment of the present invention

### DETAILED DESCRIPTION OF THE INVENTION

Referring now to the numbers in the Figures, 2 provides the overall guardrail systems, 4 provides of all posts, 6 provides all rail elements, 8 provides all cladding elements, 10 provides offsets between post(s) 4 and other elements, and 12 provides for the preferred embodiment's W-beam rail element.

The present invention involves all phases of catalytic processing including devices for performing catalytic processing, methods of making devices for catalytic processing, and methods for operating devices to perform catalytic processing. The present invention is described in terms of several specific examples but it is readily appreciated that the present invention can be modified in a predictable manner to meet the needs of a particular application. Except as otherwise noted herein, the specific examples shown herein are not limitations on the basic teachings of the present invention but are instead merely illustrative examples that aid understanding. The present invention is described using terms defined below: “Catalysis,” as the term used herein, is the acceleration of any physical or chemical or biological reaction by a small quantity of a substance—herein referred to as “catalyst”—the amount and nature of which remain essentially unchanged during the reaction. Alternatively, the term, includes applications where the catalyst can be regenerated or its nature essentially restored after the reaction by any suitable means such as but not limiting to heating, pressure, oxidation, reduction, and microbial action. For teachings contained herein, a raw material is considered catalyzed by a substance into a product if the substance is a catalyst for one or more intermediate steps of associated physical or chemical or biological reaction.

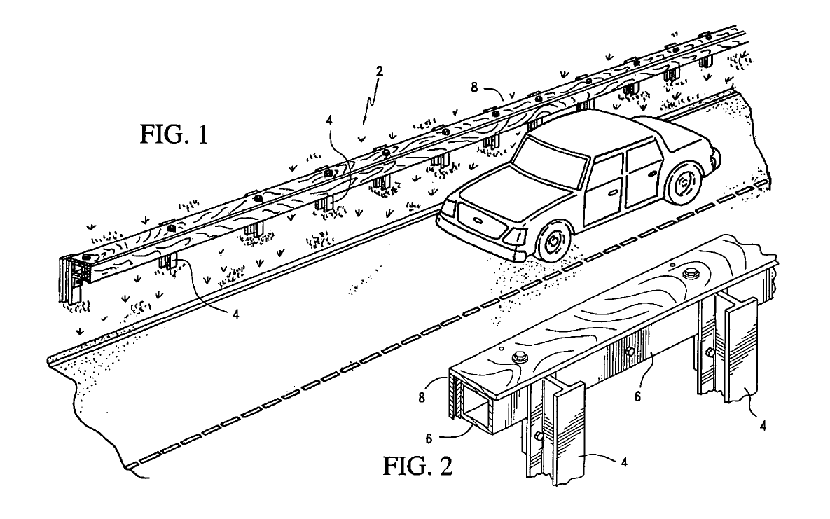

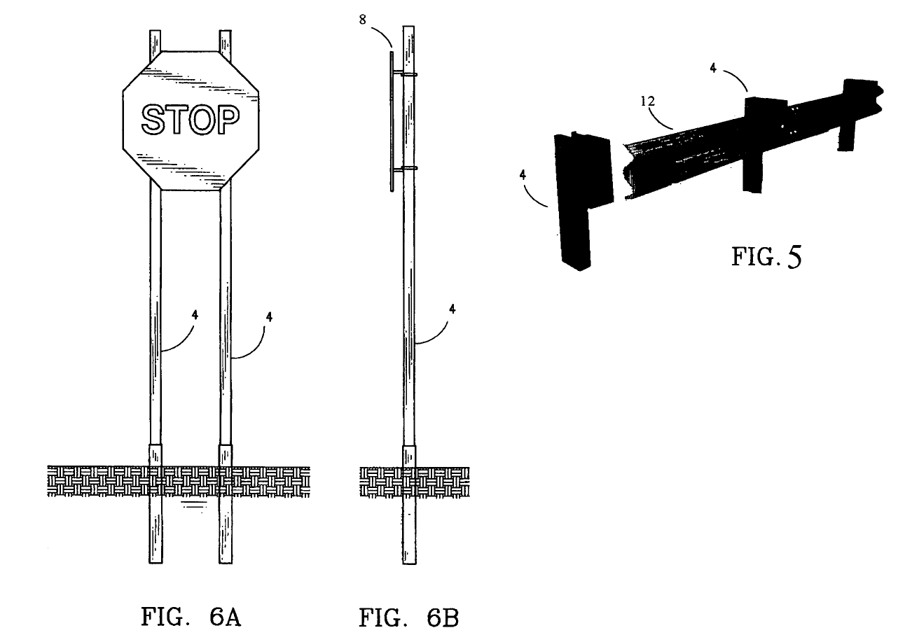

In one embodiment, a primarily titanium-dioxide and calcium-complex is formed into elements for cladding NHS-approved highway crash barriers such as referenced by Glaesener '090. Physical samples of this embodiment were constructed and placed on test, in the Summer of 2000, on private property bordering U.S. Army armored-vehicle repair and proving grounds depot test tract known for significant “smog” generation by accelerating diesel and gasoline powered heavy vehicles. These samples remain on test today. Except for some discoloration, these samples continue to be effective. Said titanium-dioxide materials were replacements for “wood-veneer” (see FIGS. 1 and 2) on U.S. Pat. No. 6,561,492 to Hubbell ('492) (a co-inventor of the present invention) devices. Following installations of the aforementioned modified '492 devices, we requested a formal review by the U.S. Federal Highway Administration (FHWA) of the '492 device, based on the use of “wood-veneer” (# 8 in FIGS. 1 and 2). Said review generated FHWA Opinion Letter HAS-1, dated Dec. 8, 2000. Said Letter points out that there is (2nd para., last sentence) “ . . . no way of predicting what the debris scatter range or extent . . . ” in the event of a vehicle impact, and as such, “ . . . would not recommend the use of this cladding in locations where pedestrian safety behind the rail is a major concern.” It should be noted that we did not reveal to FHWA the use of titanium-dioxide cladding material. However, tests suggest that the titanium-dioxide cladding material would in fact perform similar to “wood-veneer” as disclosed in '492. Use of TiO2 devices in applications not subject to the concerns raised by FHWA remain commercially viable such as using the teachings of '492 on non-crash barrier equipment located in the NHS right-of-way such the back plates of signage (FIGS. 6A & 6B) #8 and the post # 4 supports for sign and signal equipment.

Due to abovementioned FHWA Opinion Letter HAS-1, and the desire to place titanium-dioxide physically in NHS-type right-of-ways close to source points of air pollution (motor vehicles) and use existing FHWA structures such as highway guiderail systems for titanium-dioxide surfaces, another embodiment utilizes the concepts of structural composites disclosed in U.S. Pro. Pat. No. 60/540,993, incorporated in toto herein. Said structural composites are constructed, in part, of two-part resins with a metal-base catalyst, to which is added titanium-dioxide. Unlike the 60/540,993 structural composites, the now four-part (two-part resin, metal-base catalyst, plus titanium-dioxide) is the exterior working surface of the finished device. This titanium-dioxide/resin matrix surfaced NHS-approved highway crash barrier configuration was submitted for FHWA review. Said review generated FHWA Opinion Letter HAS-10, dated Aug. 9, 2004. Said Letter states (2nd para., first sentence) “ . . . that the titanium dioxide coating on the metal beam and other component of an otherwise crashworthy traffic barrier will not adversely affect the barrier's crash performance.”

Another embodiment utilizes an NHS-type guiderail, or similar structural elements, such as but not limited to U.S. Pat. No. 6,367,208 to Campbell et al., entitled “Composite Foundation Post”, and/or U.S. Pat. No. 6,409,433 to Hubbell, et al, entitled “Foundation Piles . . . ”, and/or U.S. Pat. No. 6,454,488 to Lewis, Sr., et al, entitled “Roadway Energy Absorbing Impact Attenuator”, and/or U.S. Pat. No. 6,502,805 to Lewis et. al., entitled “Sheet-Metal Highway Guardrail System”, and/or U.S. Pat. No. 6,561,492 to Hubbell, entitled “Wood clad guardrail assembly”, and/or WO 02/066745 (PCT/IS01/00005) to Jonsson et al, entitled “LATERAL LOAD BEARING STRUCTURAL CANTILEVERD SYSTEM SUCH AS HIGHWAY GUARDRAIL AND BRIDGERAIL SYSTEMS”, noting that a co-inventor of the present invention being either the inventor or co-inventor of the abovementioned patents.

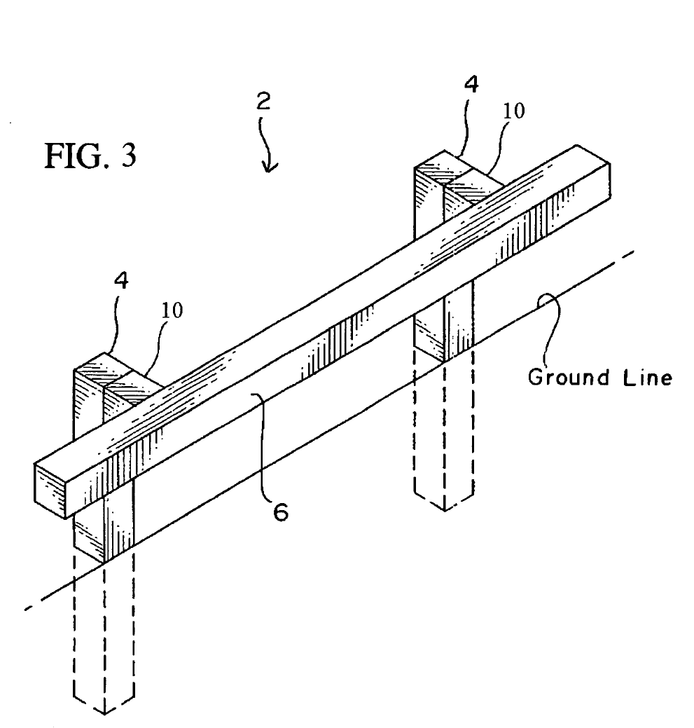

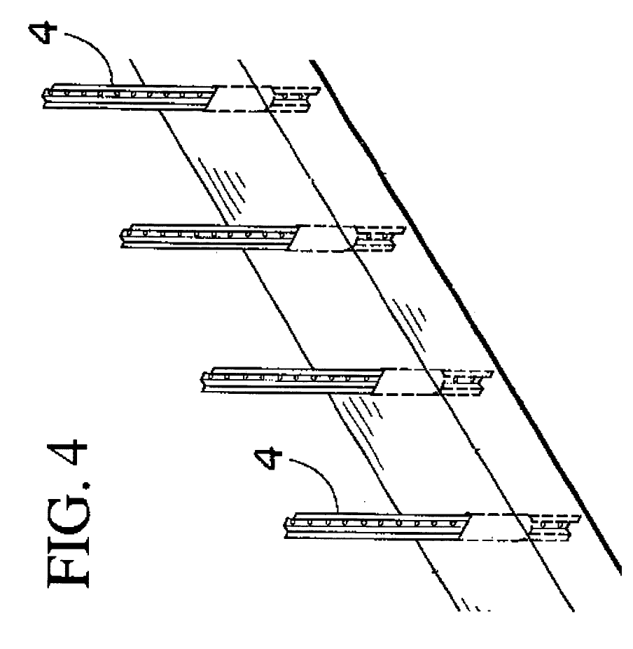

In another embodiment, portions of the structure exposed to wind and/or vehicle induced air mass movement, or are in close physical proximity to said moving vehicle, are electrically insolated (see FIG. 3) by insulating offset spacers #10 and isolating connecting hardware.

The present invention utilizes the teachings of U.S. Pat. No. 4,037,561 Jul. 26, 1977 LaFave, et al. (LaFave '561). LaFave '561 teaches that (col. 8, line 55) “ . . . there is a tendency for a static charge to build up as a result of friction from the flow of air . . . .” The present invention incorporates these and other teachings of LaFave '561 The present invention utilizes the teachings of U.S. Pat. No. 4,574,038 to Wan (Wan '038). Wan '038 teaches that (col. 4, line 3) “It is known that the surface electrons of . . . metal catalyst interact with (a) . . . electromagnetic field generated by the microwave source, thereby transforming microwave radiation into an effective form of energy.” The present invention incorporates these and other teachings of Wan '038.

The present invention utilizes the teachings of U.S. Pat. No. 5,945,231 to Narayanan, et al. (Narayanan '231). Narayanan '231 teaches of (col. 2, line 63) “ . . . increase(ing) the reactivity of a catalyst by changing the electronic properties of a catalyst layer.” The present invention incorporates these and other teachings of Narayanan '231.

The present invention utilizes the teachings of U.S. Pat. No. 6,214,195 to Yadav, et al. (Yadav '195). Yadav '195 teaches (col. 2, line 43) “ . . . a method of chemically transforming a substance through the simultaneous use of a catalyst and electrical current. This method comprises selecting an active material which interacts with an applied electromagnetic field to produce a current.” The present invention incorporates these and other teachings of Yadav '195.

The present invention's catalyses may be energized by passing air mass and/or electromagnetic field generated by physically near operating motor vehicles.

Another embodiment incorporates the fact that some catalyst (and negative catalyst) crystal melt-points are higher than the commonly used metals in highway and near-highway environs. Direct application of such catalyst crystal material to the surfaces of such metals during their final liquid state in their manufacture is possible. Applications require processes integrated with the final stages of metal production. Care is required to assure that the metal elements' surfaces are not structurally impaired. Such application(s) is(are) herein claimed. However, such metals as steel and aluminum are usually subjected to coating processes during or immediately after they solidify for a variety of reasons. These industrial coatings would prevent any embedded catalyst crystal surfaces from gaining access to the targeted chemical and/or biologic elements. U.S. Pat. No. 2,501,846 to Gifford teaches of the problems associated with such coatings. The same is true for metallurgical processes such as the galvanizing of steel and/or iron. Hoff '267, (page 1, paragraph 3) teaches to “ . . . spread a smaltzing of sand . . . ” Henry '049 (page 2, paragraph 4) teaches of “sprinkle(ing)” sand while a surface “ . . . is still hot . . . ” and in the case of titanium dioxide crystals, a texture similar to sand provides a Hoff '267-type and/or Henry '049-type application. In fact, substituting titanium dioxide in a Hoff '267-type and/or Henry '049-type device which is subject to potential abrasion allows the continued exposure of new catalyst crystal surfaces as the immediate structural substrata is abraded or eroded or otherwise reduced over time and/or use.

### Preferred Embodiment

The preferred embodiment places discrete structural elements of U.S. Federal Highway Administration (FHWA) National Cooperation Highway Research Program (NCHRP) 350 Test Level 3 galvanized steel W-beam (see FIG. 5) highway guiderail system (also known as a crash-barrier) disposed along a traffic highway lane. Said crash-barrier portion disposed along the ground along said lane and engageable with a vehicle to limit the tendency of said vehicle to leave said lane. Said vehicles, being discrete solid masses passing thru the highway lane air mass, imparting a velocity to said air mass causing said air mass to move by and apply load to said W-beam discrete structural element of said W-beam highway guiderail system. Said W-beam #12 encouraging said moving air mass to convert from a laminar state to a turbulent state. Said galvanized W-beam's surface to have been scarred, roughened or otherwise textured before application of a two-part resin of a nature influenced by the presence of zinc such that zinc acts as a catalyst encouraging said resin to “set”, mixture including a significant percent by weight of titanium-dioxide. Additional titanium-dioxide being liberally placed on said resin/titanium-dioxide matrix surface before said mixture achieves “set” thereby providing a principally titanium-dioxide dominated surface to said moving, turbulent, air mass. Said resin/titanium-dioxide matrix developing significant structural shear with said galvanized W-beam's surface resulting in a structural composite meeting the specifications of abovementioned FHWA Opinion Letter HAS-10, dated Aug. 9, 2004. Said principally titanium-dioxide surfaced W-beam being electrically insulated from its support structure and located along said traffic highway lane to be influenced by direct, indirect or reflected sunshine so as to energize said titanium-dioxide to degrade undesired material into environmentally compatible products within said fluid mass.

An additional advantage of the use of titanium dioxide as the exposed surface on highway guiderail is the reflective nature of the titanium dioxide crystals thereby providing greater visibility to the driving public especially at night or in times or conditions of limited visibility.

The preferred embodiment is described using titanium dioxide as a catalyst crystal targeted for the breakdown of “smog” and a standard, commonly encountered, U.S. Federal Highway Administration (FHWA) National Cooperation Highway Research Program (NCHRP) 350 Test Level 3 galvanized steel W-beam highway guiderail, also known as a crash-barrier. However, a person skilled in the art will understand that the teachings of the present invention would be equally applicable to other types of structural items encountered in the near-highway environment such as is mentioned or suggested by NCHRP 350, the American Association of State Highway and Transportation Officials' (AASHTO) Standard Specifications or similar transportation, architectural or industrial items exposed to fluid masses containing targeted chemical and/or biological elements. Placement of catalyst crystal surfaces and movement over said surfaces of fluid mass containing targeted chemical and/or biological elements is important to the overall efficiencies of the catalyst use.

The preferred application of catalyst crystals to surfaces is via resin, preferably to a metallic surface. The preferable resin is a “two-part” composition with its own metallic catalyst matching the metallic surface to be bonded to. As such, if the guiderail is a galvanized steel item then preferably the resin's metallic catalyst is zinc. This will tend to cause the resin when applied to the zinc-galvanized surface to “harden sooner close to the guidrails surface and allowing for more “tacky-time” to, using Hoff '267's language, “smaltz” the titanium dioxide crystals onto the resin's “tacky” surface. The addition of zinc particles to the “smaltzed” titanium crystals would then hasten the resin hardening around the “smaltzed” crystals. Any additional advantage of the use of galvanized surfaces for a structural substrata and the use of a resin having zinc as one of its catalysts and the addition of zinc particles with the intended exposed surface catalyst (such as titanium dioxide) is the formation of exposed zinc-oxide in the population of exposed surfaces, it being known (Scientific American, Feb. 6, 2002, “Smart Material Can Both Detect and Eliminate Water Pollutants) that “ . . . zinc oxide . . . ” can “ . . . degrade organic contaminants . . . ” and thereby increase the population of potential pollutants targeted and potentially degraded by the same industrial process of application of crystalline catalyst materials to the chosen structural substrata. If the guiderail or other metallic item is an aluminum item then preferably the resin's metallic catalyst is aluminum. With large metallic surface areas, subject to significant gross and/or localized temperature gradients, provision for differential thermo-expansion/contraction characteristics of the structural metallic substrata and the resin coating(s) structural substrata should be addressed such as scarfing of the resin after curing. If the in-situ environment is one of low or infrequent “cleansing” precipitation such as the Los Angeles basin or highway underpass or within covered architectural edifice also subjected to high surface particle contamination which is greater than the hydrophilic nature of the catalyst to self-clean, it is preferable for the catalyst surfaces to be either not horizontally “flat” or have a geometry which encourages pooling or puddling of liquids or fine particulates unless the said surfaces are subjected to cleansing air-mass type movements such as passing vehicles as identified by Wither '378. It being noted that as taught by Clingman, Jr. '115, frequent wetting and dehydration of solid catalyses can significantly increase said catalyses efficiency. As such, in aforementioned situations of low self-cleaning potential and/or the need to provide catalyses regeneration, it is preferably to provide additional hydrophilic structures such as polydioxolane, a hydrophilic thermoplastic, or methods as taught by U.S. Pat. No. 4,168,112 to Ellis, et al. and/or U.S. Pat. No. 5,700,559 to Sheu, et al. whereby additional moisture is generated and the moisture generated is encouraged to move across or drip or otherwise provide additional cleansing of said catalyst crystal surfaces exposed to targeted near fluid elements. In the special case of the use of titanium dioxide and/or zinc oxide as exposed surface catalyst crystals, for efficiency, it is desirable that said exposed surfaces be available to UV and near-UV wavelength radiation.

It should be clear that the invention is not limited to the use of TiO2, but could be used with any other suitable catalyst known at present or becoming known in the future.

It should be appreciated that any proposed theory presented herein is for illustrative purposes only, and the claims and disclosure should not be construed as being bound thereto.

While this invention has been described as having preferred design, it is understood that it is capable of further modification, uses and/or adaptations following in general the principle of the invention and including such departures from the present disclosure as come within known or customary practice in the art to which the invention pertains, and as may be applied to the essential features set forth, and fall within the scope of the invention or the limits of the appended claims.

1. A method of placing discrete structural elements supporting catalyses elements within a fluid mass, said fluid mass having been provided a velocity relative to said catalyses elements allowing said catalyses elements to degrade undesired material into environmentally compatible products within said fluid mass.

2. A method in accordance with claim 1; wherein said discrete structural elements are metallic.

3. A method in accordance with claim 1, wherein said catalyses elements are independently structural entities and are discretely secured to the surface of said discrete structural elements.

4. A method in accordance with claim 1, wherein said discrete structural elements are metallic and said catalyses elements form a structural composite with said discrete structural elements.

5. A method in accordance with claim 1, wherein said discrete structural elements are metallic and said catalyses elements form a structural composite with said discrete structural elements.

6. A method in accordance with claim 1, wherein said discrete structural elements are metallic and said catalyses elements form a structural composite with said discrete structural elements wherein said catalyses elements predominate selected surfaces exposed to said fluid mass.

7. A method in accordance with claim 1, wherein said fluid mass is provided a velocity relative to said catalyses elements via discrete solid masses passing thru said fluid mass.

8. A method in accordance with claim 1, wherein said fluid mass is provided a velocity relative to said catalyses elements via discrete solid masses passing thru said fluid mass, said discrete solid masses producing and distributing into said fluid mass said undesired material degradable by said catalyses elements.

9. A method in accordance with claim 1, wherein said discrete structural elements have a form encouraging said fluid mass to convert from a laminar state to a turbulent state.

10. A method in accordance with claim 1, wherein said catalyses elements are independent structural entities and have a form encouraging said fluid mass to convert from a laminar state to a turbulent state.

11. A method in accordance with claim 1, wherein said discrete structural elements are metallic and said catalyses elements form a structural composite with said discrete structural elements and have a form encouraging said fluid mass to convert from a laminar state to a turbulent state.

12. A method in accordance with claim 1, wherein said discrete structural elements are metallic and said catalyses elements form a structural composite with said discrete structural elements, wherein said catalyses elements predominate selected surfaces exposed to said fluid mass, and have a form encouraging said fluid mass to convert from a laminar state to a turbulent state.

13. A method in accordance with claim 1, wherein said catalyses elements are electrically insulated from said supporting structural elements.

14. A method in accordance with claim 1, wherein said catalyses elements are electrically insulated from said supporting structural elements and said fluid mass imparting electrical charge to said catalyses elements.

15. A method in accordance with claim 1, wherein said catalyses elements are electrically insulated from said supporting structural elements and said fluid mass is provided a velocity relative to said catalyses elements via discrete solid masses passing thru said fluid mass, and said discrete solid masses imparting electrical charge to said catalyses elements via electromagnetic fields.

16. A method in accordance with claim 1, wherein said fluid mass is the air mass above a roadway right-of-way, said air mass being provided a velocity relative to said catalyses elements via motor vehicles passing thru said air mass, said motor vehicles producing and distributing into said air mass said undesired material degradable by said catalyses elements.

17. A method in accordance with claim 1, wherein said discrete structural elements geometry provide for frequent wetting and dehydration of solid catalyses via localized environmental conditions.

18. A method in accordance with claim 1, wherein said discrete structural elements geometry with the addition of hydrophilic structures such as polydioxolane, a hydrophilic thermoplastic or similar material provide for frequent wetting and dehydration of solid catalyses via localized environmental conditions such as rainfall and sunshine.

19. A method in accordance with claim 1, wherein said catalyses elements, such as TiO₂, are fixed within a resin matrix so as to continually supply surface area with catalyses elements to said fluid mass in the event of abrasion or other damage to said matrix surface exposed to said fluid mass.
